(19) United States
(12) Patent Application Publication
(10) Pub. No.: US 2016/0210621 A1
(43) Pub. Date: Jul. 21, 2016

(54) VERIFIABLE CREDENTIALS AND METHODS THEREOF

(71) Applicant: SAL KHAN, OTTAWA (CA)

(72) Inventor: SAL KHAN, OTTAWA (CA)

(21) Appl. No.: 14/958,267

(22) Filed: Dec. 3, 2015

Related U.S. Application Data
(60) Provisional application No. 62/086,745, filed on Dec. 3, 2014.

(51) Int. Cl. G06Q 20/38; G06T 1/00

(52) U.S. Cl. CPC G06Q 20/3821; G06T 1/0021

(57) ABSTRACT

Whilst technological progress in identity (ID) documents continues to evolve, prior art systems do not ultimately prevent ID document tampering, replication, etc. by virtue of their being no unique associations of the ID document to both its physical/digital identity and the physical identity of the cardholder. Accordingly, the inventors through embodiments of the invention address these issues through the provisioning of ID documents with features that allow unique association of the ID document to both its physical/digital identity and the physical identity of the cardholder.

### FIELD OF THE INVENTION

This invention relates to personal identity management and verification and more particularly to a method and system of providing verifiable and authenticable credentials.

### BACKGROUND OF THE INVENTION

Digital identity is the data that uniquely describes a person or a thing and contains information about the subject's relationships within the digital world, commonly referred to as cyberspace, World Wide Web (WWW) or Internet. A critical problem is knowing the true identity with whom one is interacting either within electronic messaging, Internet accessible content, or transaction. Currently there are no ways to precisely determine the identity of a person in digital space. Even though there are identity attributes associated to a person's digital identity, these attributes or even identities can be changed, masked or dumped and new ones created. Despite the fact that there are many authentication systems and digital identifiers that try to address these problems, there is still a need for a unified and verified identification system. Further, there are still the needs for respecting the privacy of individuals, maintaining security of the elements of a digital identity and associating.

With the advent of widespread electronic devices the landscape for the identity (ID) documents industry has been rapidly changing with increasingly sophisticated security measures, increased electronic processing, global wireless network connectivity, and continuously expanding machine readable capabilities globally. These have evolved in order to counter the increasingly sophisticated counterfeiting and piracy methodologies that exploit the very same advances in technology and infrastructure. At the same time user expectations from ubiquitous portable electronic devices, global networks, etc. is for simplified security processes and streamlined authentication of an ID document, the user, or a transaction by the user.

Security features of ID documents currently in use globally include visual security features, machine-readable security features, and embedded passive or active electronic circuits. Visual Security Features provide easy visual control of ID documents and make them more resistant to counterfeiting and tampering through attempts at both physical and data changes. Examples of such technologies include ultraviolet (UV) and near infrared (NIR) fixed and variable-data markings, tamper-proof film overlays, fixed holograms and diffractive nanostructure layers and more recently variable-data 2D transparent holograms, and variable-data micro printing.

Machine-readable Security Features traditionally include magnetic stripes, 1D and 2D barcodes, Optical Character Recognition (OCR)/Optically Machine Readable (OMR) content in printed areas or Machine Readable Zones (MRZs). More advanced ID documents may also include contact and contactless interfaces microchips including RFID and smart cards. Such Machine-readable Security Features have varying memory capacity and typically replicate digitally the document data with additional unique identifiers and, in the case of microchips with sufficient data storage capabilities, additional biometric identification data for holder authentication may be included.

As a necessary complement to these ID document security features are printed visible variable textual attributes about both the document holder and the document itself, such as name, address, expiry date, document identifier, etc. Such variable textual data may also include some security features such as micro-printing, UV or NIR inks and affixed optical overlays in order to render any tamper attempts or tampering detectable. Finally, as a primary human identification feature for the ID documents, printed, laser engraved or affixed variable graphic information such as holder photograph and signature may also be present, providing physical confirmation of the holder apparent identity.

Whilst technological progress in such ID documents continues to evolve, these systems do not prevent ultimately prevent ID document tampering, replication, etc. by virtue of their being no unique associations of the ID document to both its physical/digital identity and the physical identity of the cardholder. Accordingly, the inventors address these issues through the provisioning of ID documents with features allowing unique associations of the ID document to both its physical/digital identity and the physical identity of the cardholder.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to real world and virtual world identities and more particularly to authenticating users within the virtual world based upon credentials issued in response to validated and authenticated real world identities.

In accordance with an aspect of the invention there is provided a method comprising providing a user with a physical credential comprising data embedded within a fractal image comprising a predetermined portion of the content patterned onto the physical credential.

In accordance with an aspect of the invention there is provided a method comprising providing a method of securing a physical document comprising providing as part of the physical document a fractal image comprising data embedded within the fractal image comprising a predetermined portion of the content of the physical document.

In accordance with an aspect of the invention there is provided a method comprising providing a method of verifying an electronic transaction comprising providing as part of the electronic transaction a fractal image comprising data embedded within the fractal image comprising a predetermined portion of the electronic transaction.

In accordance with an aspect of the invention there is provided a method of digitally securing an item of content by generating a fractal image for incorporation with the item of content, wherein the fractal image is generated using a fractal generation process that is both deterministic and stochastic.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1 and 2 depict a first portion of a real world and virtual world identity ecosystem according to an embodiment of the invention;

FIG. 3 depicts an identity document matching architecture at a store front relying party according to an embodiment of the invention;

FIG. 4 depicts a network environment within which embodiments of the invention may be employed;

FIG. 5 depicts a wireless portable electronic device supporting communications to a network such as depicted in FIG. 4 and as supporting embodiments of the invention;

FIG. 6 depicts an architecture for a card stock provider and card manufacturing process according to an embodiment of the invention to provide unique base cards through mechanical and non-visible features according to an embodiment of the invention;

FIGS. 7A and 7B depict the sequential application of mechanical and non-visible features to generate unique base card stock prior to the application of conventional prior art identity and security features according to an embodiment of the invention according to embodiments of the invention;

FIG. 8A depicts the application of fractal imagery and embedded encrypted data within the fractal imagery in combination with conventional prior art identity and security features according to an embodiment of the invention;

FIG. 8B depicts an exemplary process flow for embedding data within a fractal image to form part of a card according to an embodiment of the invention;

FIG. 9 depicts the application of fractal imagery and embedded encrypted data within the fractal imagery in combination with conventional prior art identity and security features according to an embodiment of the invention;

FIG. 10 depicts the application of fractal imagery and embedded encrypted data within the fractal imagery in conjunction with mechanical and non-visible features to generate unique base card stock prior to the application of conventional prior art identity and security features according to an embodiment of the invention;

FIG. 11 depicts the application of data embedded fractal images and distributed embedded pictographic icons according to embodiments of the invention together with establishing biometric data for embedding within a fractal image;

FIG. 12 depicts the application of fractal images with embedded data as part of financial transactions upon a user's PED according to an embodiment of the invention.

### DETAILED DESCRIPTION

The present invention is directed to real world and virtual world identities and more particularly to authenticating users within the virtual world based upon credentials issued in response to validated and authenticated real world identities.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, client, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” or “credential holder” as used herein refers to an individual who, either locally or remotely, by their engagement with a service provider, third party provider, enterprise, social network, social media etc. via a dashboard, web service, web site, software plug-in, software application, or graphical user interface provides an electronic credential as part of their authentication with the service provider, third party provider, enterprise, social network, social media etc. This includes, but is not limited to, private individuals, employees of organizations and/or enterprises, members of community organizations, members of charity organizations, men, women, children, and teenagers. “User information” as used herein may refer to, but is not limited to, user identification information, user profile information, and user knowledge.

A “security credential” (also referred to as a credential) as used herein may refer to, but is not limited to, a piece of evidence that a communicating party possesses that can be used to create or obtain a security token. This includes, but is not limited to, a machine-readable cryptographic key, a machine-readable password, a cryptographic credential issued by a trusted third party, or another item of electronic content having an unambiguous association with a specific, real individual. Such security credentials may include those that are permanent, designed to expire after a certain period, designed to expire after a predetermined condition is met, or designed to expire after a single use.

A “government issued photographic identity document” as used herein may refer to, but is not limited to, any document, card, or electronic content item issued by a government body for the purposes of identifying the owner of the government issued photographic identity document. Such government bodies may, for example, be provincial, federal, state, national, and regional governments alone or in combination. Such government issued photographic identity documents, also referred to within this specification as Photo-ID cards, government issued photographic cards, and government issued identity documents may include, but are not limited to, a driver's license, a passport, a health card, national identity card, and an immigration card although they have the common feature of a photographic image, multimedia image, or audiovisual image of the user to whom the government issued photographic identity document was issued. Such government issued photographic identity documents may include, but not be limited to, those comprising single sided plastic card, double sided plastic cards, single sided sheets, double side sheets, predetermined sheets within a book or booklet, and digital representations thereof in isolation or in combination with additional electronic/digital data that has been encoded/encrypted. For example, a digital memory with fingerprint scanner in the form of what is known as a “memory stick” may be securely issued by a government body as the fingerprint data for the user is securely encoded and uploaded together with image and digital content data. Subsequently, the digital memory when connected to a terminal and activated by the user's fingerprint may transfer the required digital data to the terminal to allow for a verification that the user is the one and the same. Such memory devices can be provided which destroy or corrupt the data stored within upon detection of tampering.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as those for example listed on Wikipedia (see http://en.wikipedia.org/wiki/List of file formats). Within a broader approach digital content may include any type of digital information that is at least one of generated, selected, created, modified, and transmitted in response to a request, wherein said request may be a query, a search, a trigger, an alarm, and a message for example.

“Encryption” as used herein may refer to, but are not limited to, the processes of encoding messages or information in such a way that only authorized parties can read it. This includes, but is not limited to, symmetric key encryption through algorithms such as Twofish, Serpent, AES (Rijndael), Blowfish, CASTS, RC4, 3DES, and IDEA for example, and public-key encryption through algorithms such as Diffie-Hellman, Digital Signature Standard, Digital Signature Algorithm, ElGamal, elliptic-curve techniques, password-authenticated key agreement techniques, Paillier cryptosystem, RSA encryption algorithm, Cramer-Shoup cryptosystem, and YAK authenticated key agreement protocol.

The dual purposes of ID documents are to ascertain the virtual identity of the holder through providing a valid and authentic document, and also for a human authorized agent to identify the physical person as the rightful owner of the document, therefore binding in-person the physical identity to the virtual one. Whilst most security features are targeted at validating or increasing confidence in the authenticity of the ID document itself the second aspect of visual verification is subject to human limitations such as fatigue as well as variations in individual, environmental, and physical conditions. This is normally remedied by supplementing human validation with sophisticated equipment such as ID document scanners that perform automated OCR/OMR and data cross-checking, providing some level of validation automation. Further, given many security features involve micro-printing, NIR or UV markings, RFID, and smartcard microchips, it is safe to say that only such equipment can reliably read these and validate certain aspect of these. Within U.S. Provisional Patent Application 61/980,785 entitled “Methods and Systems relating to Real World Document Verification”, the entire contents of which are incorporated herein, the inventors have presented a methodology and systems for uniquely verifying a physical ID card by establishing unique ID cards that are bound to a user's identity by an issuing authority. Accordingly, prior art identity replication and/or theft methodologies are halted as even a complete re-printing and re-programming of the ID card cannot remove the original binding of the ID card to an individual. However, it would be beneficial to expand the ID documents that could be protected by such unique bindings at issuance.

Conversely, the task of validating the physical identity of the ID document holder with the photo on the document, or the photo on another document of the same name such as a government issued ID, is optimally suited to the human agent today. As a biometric identifier, the matching of a user photo to their face is easily and quickly performed in person whereas with the current status of electronic solutions this is something more difficult to achieve reliably with facial recognition and face matching technology.

Accordingly, it would be beneficial for improved focus to be applied to photographic images within ID documents. As will become evident embodiments of the invention provide solutions supporting enhanced photographic and/or digital imagery to ensure enhanced usability for both visual authentication and easy readability without requiring high cost scanning or camera devices, allowing within the supported embodiments entirely digital mobile ID documents. Accordingly, embodiments of the invention may cross easily into the all-digital world whereas nearly all other prior art security features require a physical card making them self-limiting when considering migration to electronic ID documents and forcing adoption of secondary methodologies and credentials.

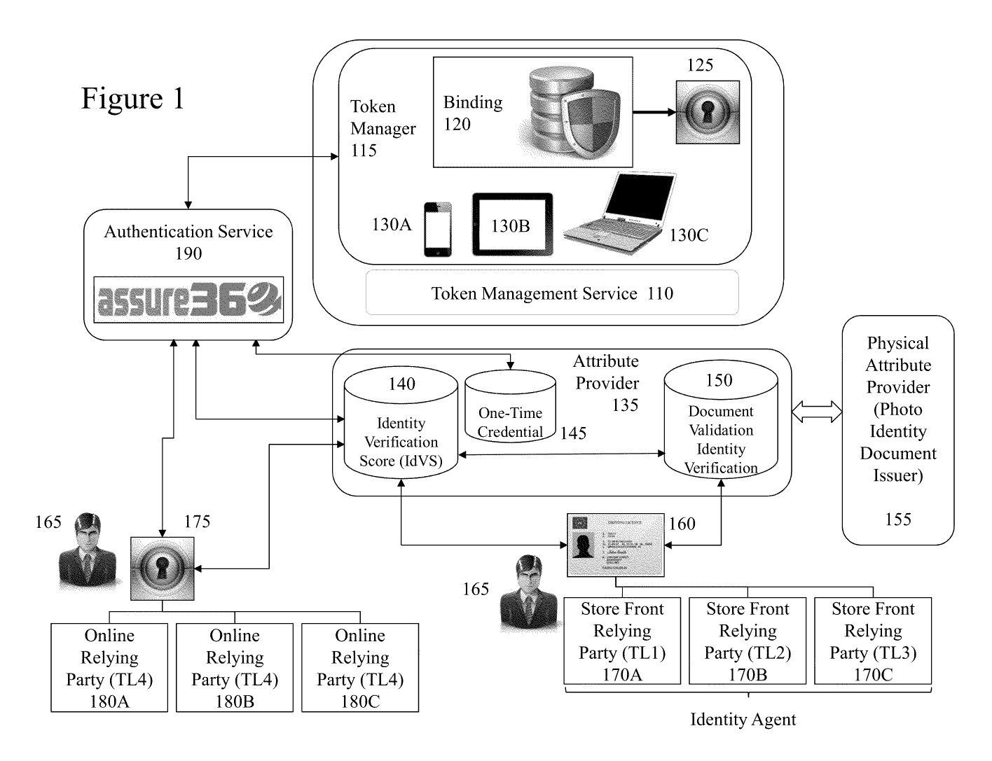

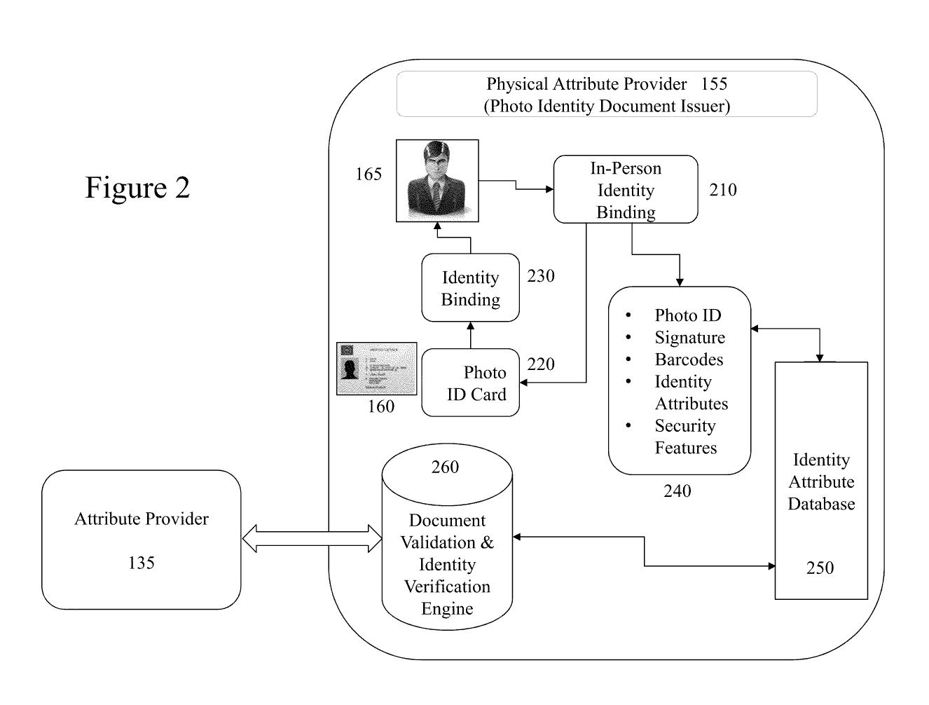

Referring to FIGS. 1 and 2 there are depicted first and second portions of a real and virtual world identity ecosystem (RVWIE) according to an embodiment of the invention. As depicted in FIG. 1 this RVWIE comprises a physical attribute provider (PHYSAP) 155 in communication with an attribute provider 135. The PHYSAP 155 being depicted schematic as process flow detail in FIG. 2. The PHYSAP 155 represents an identity document issuer wherein the identity document includes a photograph of the user 165 to whom it relates. Accordingly, the PHYSAP 155 is a government issuing authority or an authority licensed by a government to issue identity documents. The government authority may be national, provincial, federal, or state for example. Such identity documents may include, but are not limited to, a driver's license, a passport, a health card, national identity card, and an immigration card.

Accordingly, a credential holder (user 165) is identity-proofed in-person by a trusted agent of the government photographic identity issuing authority, PHYSAP 155. This process step 210 results in the issuance of Photo-ID card 160 (step 220) and the credential holder's proofed identity being bound (step 230) to the government photographic identity document. As a result of this sequence the credential holder's identity-proofed attributes being stored in step 240 within a government Identity Attribute Database 250 managed by the document issuer. Attributes stored in respect of the credential holder within the Identity Attribute Database 250 may include, but not be limited to, the photograph of the user 165, the signature of the user 165, the user's name and address, type of document, and date of issue. The information within the Identity Attribute Database 250 is also accessible by a Document Validation and Identity Verification Engine (DVIVE) 260 which is in communication with an Attribute Provider 135.

Subsequently, the user 165 (credential holder) uses their Photo-ID card 160 at a storefront retailer/government office or kiosk/enterprise, depicted as first to third store front relying parties 170A to 170C respectively, to identify themselves in the presence of an agent of the store front relying party. The first to third store front relying parties 170A to 170C each exploit a Photo-ID checker, referred to within this specification as a Ping360 system/device. According to the identity of the first to third store front relying parties 170A to 170C respectively these are allocated different trust levels. For example:

Trust Level 1 (TL1)—government office, civic authority, e.g. another government Photo-ID issuing authority or government/civic office where the credential holder's identity is proofed, having higher trust level than other relying parties.

Trust Level 2 (TL2)—financial institutions, e.g. a bank, having a higher trust level than other relying parties, such as retailers, etc. but not at a level not as high as relying parties at a Trust Level 1.

Trust Level 3 (TL3)—all other identity agents, not included in the above trust levels 1 and 2 respectively.

An additional trust level, Trust Level 4 (TL4), is associated with online merchants as indicated in FIG. 1 with first to third online relying parties 180A to 180C respectively. This trust level, TL4, may also be associated with online activities with a government, government regulated body, online enterprise etc. Whilst embodiments of the invention are described as having four trust levels (TL1 to TL4 respectively) it would be evident that within alternate embodiments a higher or lesser number of trust levels may be employed. However, for each trust level the activities of a user are tracked and stored within the databases as described with respect to embodiments of the invention and employed as described below in generating an Identity Verification Score for the user with the government issued photographic identity document.

Whilst embodiments of the invention are described as having four trust levels (TL1 to TL4 respectively) it would be evident that within alternate embodiments a higher or lesser number of trust levels may be employed. The Ping360 system, located at the store front relying party's place of business and not shown for clarity, interacts with the Attribute Provider 135 to validate the Photo-ID card 160 and verify the identity of the document bearer, user 165. Accordingly, the Ping360 system acquires data from and about the Photo-ID card 160 and communicates this to a Document Validation Identity Verification database (DVIVDb) 150 which then communicates with the DVIVE 260 within the PHYSAP 155. The DVIVE 260 thereby confirms or denies the validity of the Photo-ID card 160 presented by the user 165 at the one of the first to third store front relying parties 170A to 170C respectively. The DVIVE 260 extracts data from the Identity Attribute Database 250 as part of the validation activity.

Accordingly, the Ping360 system validates the Photo-ID card 160 as being genuine or counterfeit. As described supra the Ping360 system extracts characteristic information from the Photo-ID card 160 which is transmitted to the DVIVDb 150 managed and controlled by Attribute Provider 135. The extracted characteristics are then provided to DVIVE 260 wherein they are compared with data extracted from Identity Attribute Database 250 and a resulting validation/denouncement of the Photo-ID card 160 is communicated back to the DVIVDb 150 and therein back to the Ping360 for presentation to the agent of the store front relying party. Extracted characteristics may include, but are not limited to, the photograph on the Photo-ID card 160, a signature, identity information of the Photo-ID card 160, barcode data, QR code data, data within magnetic stripe(s), etc. as well as potentially characteristics of the card itself.

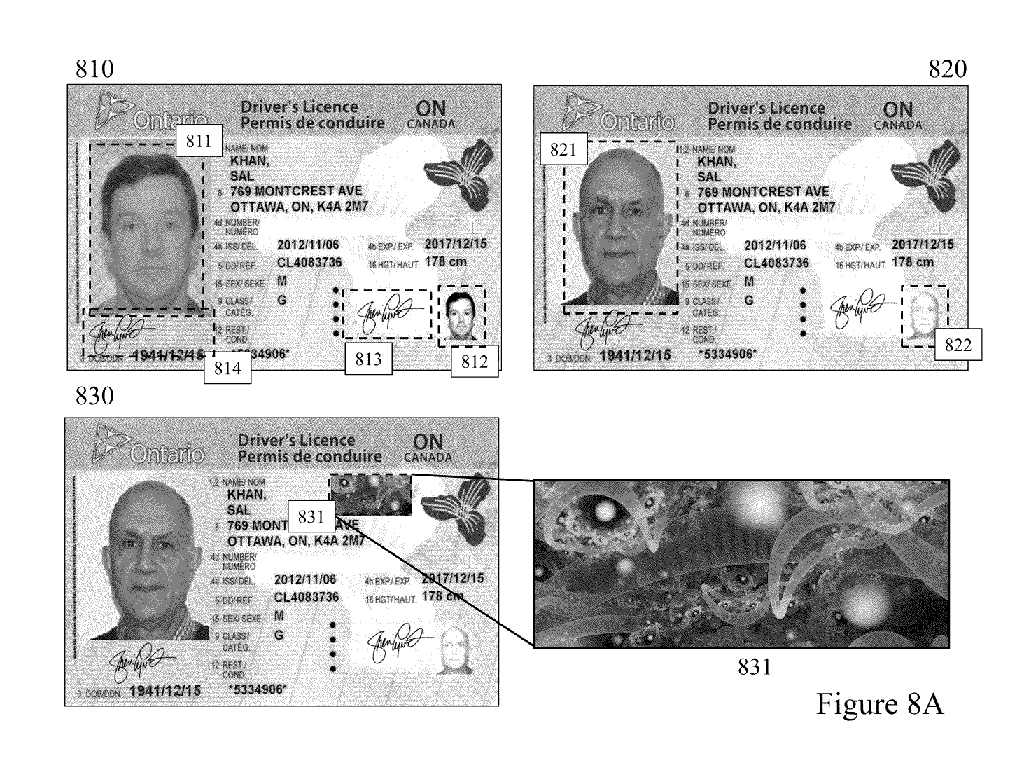

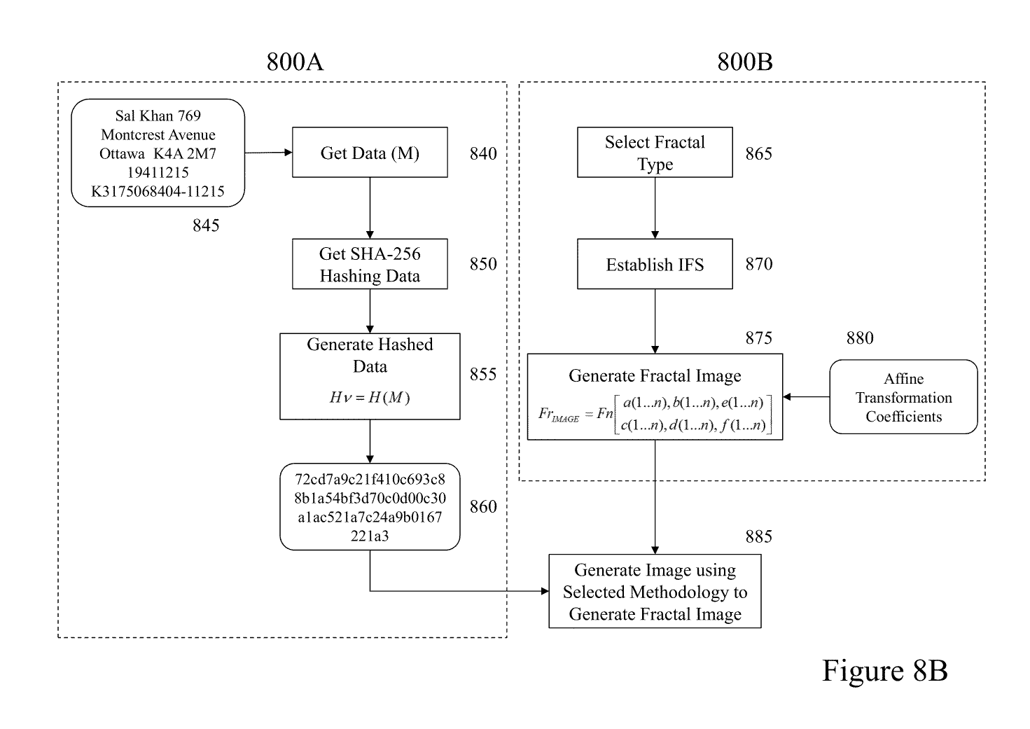

The data within the Identity Attribute Database 250 maintained and acquired/generated by the PHYSAP 155 relating to the Photo-ID card 160 when the user 165 applied for, or renewed, their Photo-ID card 160. Accordingly, the user 160 during the course of doing business at various retail service provider's locations, the credential holder's (user 165) Photo-ID card 160 is validated and their identity verified by Attribute Provider's 135 DVIVDb 150. Therefore, each time the user's 165 Photo-ID card 160 (or Photo-ID document) is validated and the bearer's identity is verified by the combination the Ping360 system, DVIVDb 150, and DVIVE 260 as being genuine and not fake, then the credential holder's in-person verified identity is also confirmed as being genuine. As depicted and described below in respect of FIG. 8 the Attribute Provider 135 also generates one or more Identity Verification Scores (IdVS) which are subsequently stored within an Identity Verification Score database 140. As a result, Ping360 software is able to generate a quantified measure of the credential holder's identity and inform participating businesses, employers, and organizations of the strength of the credential holder's identity.

An Identity Verification Score (IdVS) may be considered to be similar to a FICO score, which is used by financial institutions to help them make complex, high-volume decisions and grant credit to a user. As described in more detail below, and as established supra, in order to create a representative IdVS for each credential holder (user 165), where their Photo-ID card 160 is verified by a Ping360 system, a trust level (TL) for each storefront relying party (Identity Agent) is established as outlined supra in dependence upon the storefront retailing party class, e.g. financial institutions have higher trust level than a retailer but not as high as a government office or civic authority office. In addition to trust level an IdVS computation according to embodiments of the invention may take into account the number of times the credential holder's photo-ID document is validated and the credential holder's identity verified.

As depicted in FIG. 1 IdVS data is also available for use by online relying parties, such as first to third online relying parties 180A to 180C respectively who may also act as identity agents for Attribute Provider 135. It is also available for use by online authentication services, such as for example, Authentication Service 190 depicted as Assure 360 Identity Assurance Service. The user 165, upon being verified through PHYSAP 155, may establish an account with an Attribute Provider 135 by forwarding an electronic mail address through an Identity Agent, depicted within FIG. 1 by first to third store front relying parties 170A to 170C respectively, via a Ping360 display, e.g. a tablet electronic device. The user 165 may have the ability to choose an Attribute Provider 135 from multiple Attribute Providers 135 as part of the process performed through an Identity Agent where they provide their electronic mail address. Optionally, the ability of a user 165 to communicate with and/or open an account with an Attribute Provider 135 may be restricted to a store front relying party at only one or more trust levels, e.g. those with trust level 1 (TL1) only for example. Additionally, the user 165 may be prevented from accessing an Identity Agent to establish the account with an Attribute Provider 135 until at least one or a predetermined number of activities have been completed with the store front relying parties at the appropriate trust levels. Further, the Identity Agent may only be accessed by the user 165 upon an authentication of their identity at the store front relying party by an action of an agent of the store front relying party.

The user 160 may then select an Authentication Service 190 from those provided by the Attribute Provider 135 web site of the Attribute Provider 135 the user 165 has selected. The Attribute Provider 135 sends a one-time-credential retrieved from One-Time Credential database 145 to the selected Authentication Service 190 and a credential 175 to the credential holder (user 160). Attribute Provider 135 also sends the Authentication Service 190 information required by the Authentication Service 190 to open an online account in the credential holder's name. Optionally, the user 165 may be presented with separate lists of Attribute Providers 135 and Authentication Services 190 during their establishment of the account or subsequently the user 165 may access any Authentication Service 190 rather than only a subset of them associated with the selected Attribute Provider 135. The credential holder can use the one-time credential sent by Attribute Provider 135 to identify themselves to the selected Authentication Service 190 to confirm the online account which was opened automatically on the credential holder's behalf by the Authentication Service 190 when the Authentication Service 190 received the one-time-credential and the credential holder's information necessary to open an account. Once the account with the Authentication Service 190 is active the credential holder can link their PED and/or FED to the Authentication Service 190's server by downloading the Authentication Service 190's client and related digital security certificates onto their PED and/or FED. A security certificate exchange takes place between the Authentication Service 190 and the Token Management Service 110, which may for example be upon a server associated with the Authentication Service 190 or may be upon a server associated with a third party. Accordingly, the Token Management Service 110 comprises a Token Manager 115 that binds, denoted by Binding 120, the digital security certificates 125 to the user's 160 PEDs/FEDs such as depicted by first to third devices 130A to 130C respectively.

As a result the credential holder's identity is bound to the credential holder's PEDs and/or FEDs and to the Authentication Service 190/Token Management Service 110 thereby providing to one of the first to third online relying parties 180A to 180C respectively with strong authentication and Level 3, in-person, verified identity assurance. Based on the credential holder's IdVS, which is obtained from Identity Verification Score database 140 the Attribute Provider 135 can provide Authentication Service 190, and other authentication services, with revocation status information on the credential holder. Accordingly, the Authentication Service 190 may revoke, cancel, or not authenticate the security credential 175 of the user 165. It would be evident that in some embodiments of the invention the Authentication Service 190 does not retain or store the one-time credentials 175.

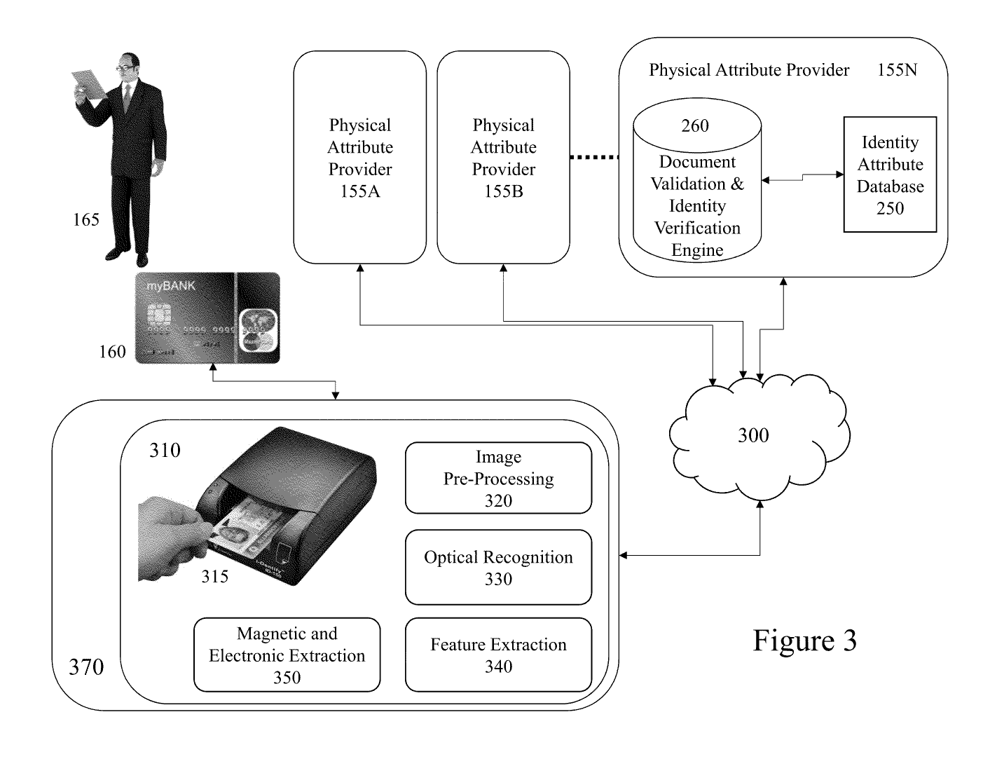

Referring to FIG. 3 there is depicted a card credential matching architecture at a store front relying party according to an embodiment of the invention as part of a RVWIE such as depicted in FIGS. 1 and 2 respectively. Accordingly, part of the RVWIE is depicted by PHYSAPs 155A to 155N respectively in respect of a user 165 and their card credential 160. Accordingly, the user 165 visits a store front relying party 370, such as described supra in respect of FIGS. 1 and 2 respectively by first to third store front relying parties 170A to 170C respectively. Depicted as part of a store front relying party 370 is a CARd CRedential chECker (CARCREC) system 310 comprising in addition to the terminal 315 modules including, but not limited to, those providing image pre-processing 320, optical character recognition (OCR) 330, feature extraction 340, and magnetic/electronic extraction 350 for example. Accordingly, the user presents their card credential 160 at the store front relying party 270 wherein an agent of the store front relying party 370 inserts the card credential 160 into the terminal 315 wherein the image pre-processing 320, optical character recognition (OCR) 330, feature extraction 340, and magnetic/electronic extraction 350 modules extract their information wherein this is communicated via network 300 to an appropriate one of the PHYSAPs 155A to 155N respectively via an Attribute Provider, not shown for clarity. For example, if the card credential 160 is a California driver's license then the PHYSAP may be part of the California Department of Motor Vehicles or alternatively if the card credential 160 is a US passport then the PHYSAP may be associated with the US Department of State.

The information derived from the card credential 160 by the CARCREC system 310 are communicated to a DVIVE 260 within PHYSAP 155 which extracts information from the Identity Attribute Database 250 in dependence upon elements of the extracted information to establish whether the user 265 is the legitimate owner of the card credential 160 or not. The resulting determination is then provided back to the CARCREC system 310 via the Attribute Provider, not shown for clarity, for display to the agent of the store front relying party 370.

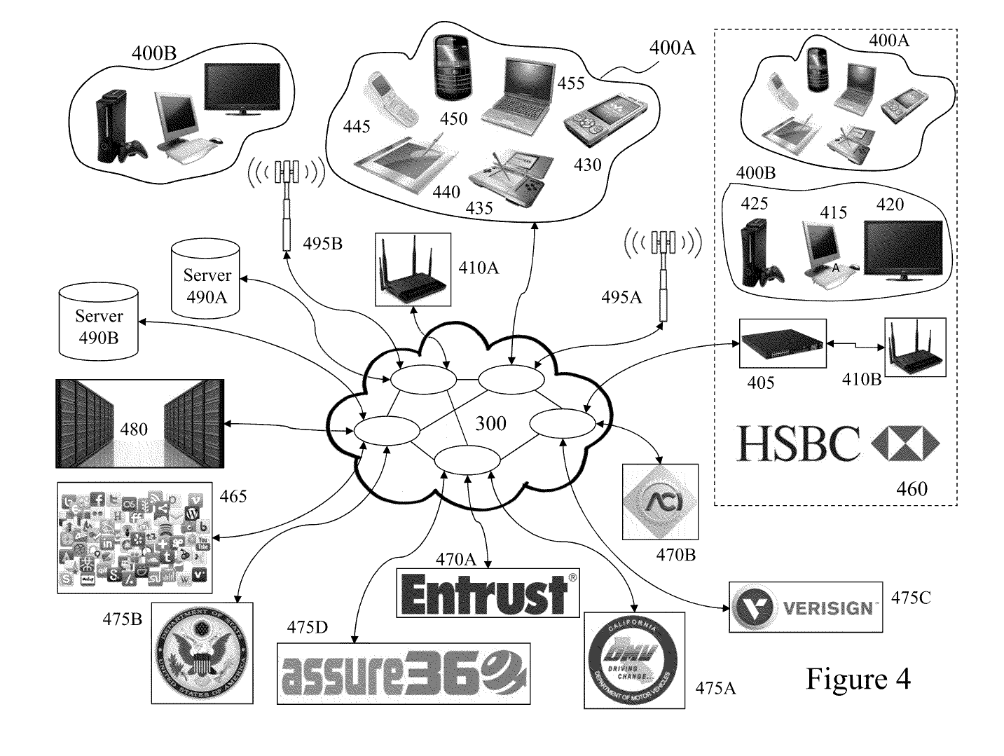

Referring to FIG. 4 there is depicted a network 100 within which embodiments of the invention may be employed supporting real world and virtual world identity ecosystems (RVWIEs) according to embodiments of the invention. Such RVWIEs, for example supporting activities such as the establishment of real world identity assurance, Level 3 assurance to physical store front relying enterprises, the binding of real world identity to electronic devices, and the provisioning of Level 3 identity verification to online retail relying enterprises. As shown first and second user groups 400A and 400B respectively interface to a telecommunications network 100. Within the representative telecommunication architecture a remote central exchange 480 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 480 is connected via the network 100 to local, regional, and international exchanges (not shown for clarity) and therein through network 100 to first and second cellular APs 495A and 495B respectively which provide Wi-Fi cells for first and second user groups 400A and 400B respectively. Also connected to the network 100 are first and second Wi-Fi nodes 410A and 410B, the latter of which being coupled to network 100 via router 405. Second Wi-Fi node 410B is associated with Enterprise 460, e.g. HSBC™, within which other first and second user groups 400A are and 400B. Second user group 400B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 405.

Within the cell associated with first AP 410A the first group of users 400A may employ a variety of PEDs including for example, laptop computer 455, portable gaming console 435, tablet computer 440, smartphone 450, cellular telephone 445 as well as portable multimedia player 430. Within the cell associated with second AP 410B are the second group of users 400B which may employ a variety of FEDs including for example gaming console 425, personal computer 415 and wireless/Internet enabled television 420 as well as cable modem 405. First and second cellular APs 495A and 495B respectively provide, for example, cellular GSM (Global System for Mobile Communications) telephony services as well as 3G and 4G evolved services with enhanced data transport support. Second cellular AP 495B provides coverage in the exemplary embodiment to first and second user groups 400A and 400B. Alternatively the first and second user groups 400A and 400B may be geographically disparate and access the network 100 through multiple APs, not shown for clarity, distributed geographically by the network operator or operators. First cellular AP 495A as show provides coverage to first user group 400A and environment 470, which comprises second user group 400B as well as first user group 400A. Accordingly, the first and second user groups 400A and 400B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 400A may form associations either through standards such as IEEE 802.15 and Bluetooth as well in an ad-hoc manner.

Also connected to the network 100 are Social Networks (SOCNETS) 465, first and second Attribute Providers 470A and 470B respectively, e.g. Entrust™ and ACI Worldwide™ first and second government photographic identity providers 475A and 475B respectively, e.g. California Department of Motor Vehicles and US Department of State, and first and second Authentication Services 475C and 475D respectively, e.g. Verisign™ and Assure 360™, as well as first and second servers 490A and 490B which together with others, not shown for clarity. First and second servers 490A and 490B may host according to embodiments of the inventions multiple services associated with a provider of publishing systems and publishing applications/platforms (RVWIEs); a provider of a SOCNET or Social Media (SOME) exploiting RVWIE features; a provider of a SOCNET and/or SOME not exploiting RVWIE features; a provider of services to PEDS and/or FEDS; a provider of one or more aspects of wired and/or wireless communications; an Enterprise 460 exploiting RVWIE features; license databases; content databases; image databases; content libraries; customer databases; websites; and software applications for download to or access by FEDs and/or PEDs exploiting and/or hosting RVWIE features. First and second primary content servers 490A and 490B may also host for example other Internet services such as a search engine, financial services, third party applications and other Internet based services.

Accordingly, a user may exploit a PED and/or FED within an Enterprise 460, for example, and access one of the first or second servers 490A and 490B respectively to perform an operation such as accessing/downloading an application which provides RVWIE features according to embodiments of the invention; execute an application already installed providing RVWIE features; execute a web based application providing RVWIE features; or access content. Similarly, a user may undertake such actions or others exploiting embodiments of the invention exploiting a PED or FED within first and second user groups 400A and 400B respectively via one of first and second cellular APs 495A and 495B respectively and first Wi-Fi nodes 410A.

As noted supra first and second servers 490A and 490B together with others may host a variety of software systems and/or software applications supporting embodiments of the invention. However, embodiments of the invention may not only operate locally, regionally, or nationally but internationally and globally. Accordingly, some servers may manage and control operations in execution upon other servers. For example, an Authentication Service such as Authentication Service 190 in FIG. 1 (e.g. Assure360) may operate a server or servers within one or more jurisdictions which authenticate, using one or more machine authentications techniques servers, within that jurisdiction as well as other jurisdictions. Each jurisdiction server may be operated by the same Authentication Service as manages the supervisory servers or it may be operated by one or more Identity Authority Servers authorised by the Authentication Service managing the supervisory servers. Optionally, such providers of Authentication Services may be regulated by government regulatory bodies within their respective jurisdictions. As noted supra as the verification processes are performed on firewalled servers associated with the physical attribute provider (PHYSAPs) then data relating to true original government issued photographic identity documents is maintained secure and private whilst the only information transmitted from a store front relying party is the extracted data for the presented government issued photographic identity document and that transmitted from a PHYSAP is the result of the verification/validation process. Similarly, data transmitted from an Attribute Provider is restricted, e.g. only the Identity Verification Score (IdVS) provided from the Attribute Provider server, e.g. Ping360 server, to the card reader at the store front relying party, e.g. Store Front Relying Party (TL1) 170A.

Accordingly, where government issued photographic identity cards are standardized, e.g. driver′ licenses in all member states of the European Community, then the processes relating to the store front relying parties may be similarly tracked and employed across multiple jurisdictions. Alternatively, the user may transact business within another jurisdiction based upon the validation and verification of their identity. In such instances where a jurisdiction server (e.g. a country server) is transacting on behalf of a user (e.g. doing business or presenting their government issued photographic identity card) in another jurisdiction (e.g. country) then the two jurisdiction servers will first identify themselves before the user's digital identity will be assured by the jurisdiction server in the jurisdiction they live. Due to different provincial, state, territorial, differences such jurisdictions may include different states, regions, territories, etc., for example.

It would be evident that authentication may be conducted by an online relying party in the country in which the user is conducting business or by the user's Identity Provider (if the user uses one), if the online relying party the user is transaction with is networked with the user's Identity Provider. It would be evident that some enterprises and/or organizations acting as online relying parties, e.g. Google, American Express, HSBC and Facebook, may act as global identity providers whereas other online relying parties, e.g. Verizon and Chase Manhattan, may be only US identity providers.

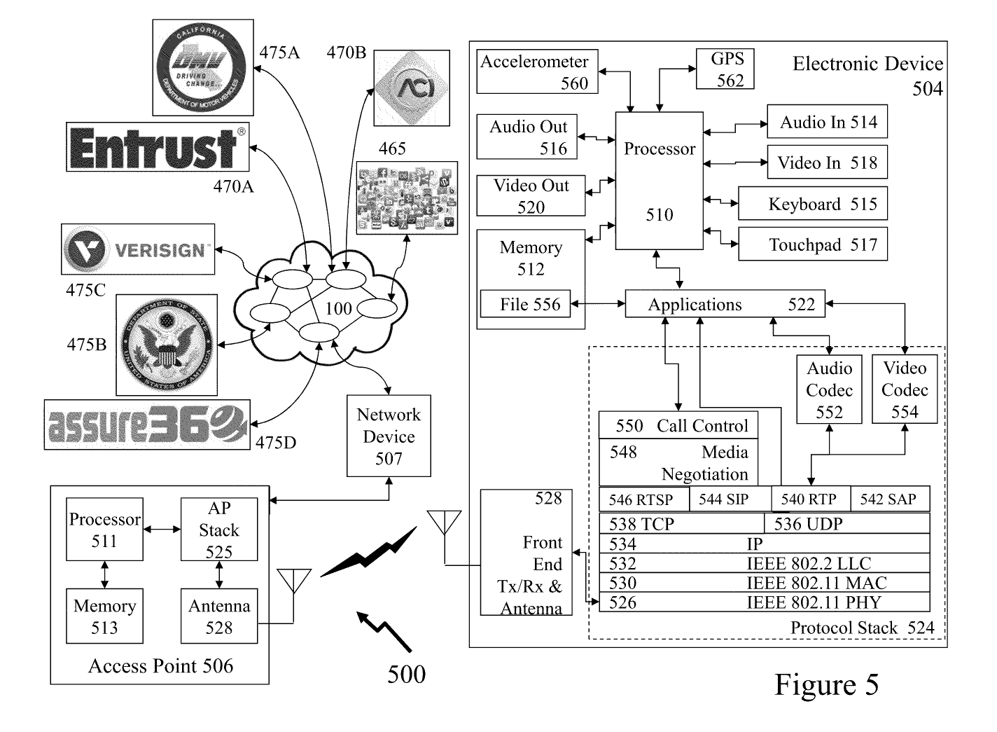

Now referring to FIG. 5 there is depicted an electronic device 504 and network access point 507 supporting RVWIE features according to embodiments of the invention. Electronic device 504 may, for example, be a PED and/or FED and may include additional elements above and beyond those described and depicted. Also depicted within the electronic device 504 is the protocol architecture as part of a simplified functional diagram of a system 500 that includes an electronic device 504, such as a smartphone 455, an access point (AP) 506, such as first AP 410, and one or more network devices 507, such as communication servers, streaming media servers, and routers for example such as first and second servers 490A and 490B respectively. Network devices 507 may be coupled to AP 506 via any combination of networks, wired, wireless and/or optical communication links such as discussed above in respect of FIG. 4 as well as directly as indicated. Network devices 507 are coupled to network 100 and therein Social Networks (SOCNETS) 465, first and second Attribute Providers 470A and 470B respectively, e.g. Entrust™ and ACI Worldwide™, first and second government photographic identity providers 475A and 475B respectively, e.g. California Department of Motor Vehicles and US Department of State, and first and second Authentication Services 475C and 475D respectively, e.g. Verisign™ and Assure 360™.

The electronic device 504 includes one or more processors 510 and a memory 512 coupled to processor(s) 510. AP 506 also includes one or more processors 511 and a memory 513 coupled to processor(s) 510. A non-exhaustive list of examples for any of processors 510 and 511 includes a central processing unit (CPU), a digital signal processor (DSP), a reduced instruction set computer (RISC), a complex instruction set computer (CISC) and the like. Furthermore, any of processors 510 and 511 may be part of application specific integrated circuits (ASICs) or may be a part of application specific standard products (ASSPs). A non-exhaustive list of examples for memories 512 and 513 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 504 may include an audio input element 514, for example a microphone, and an audio output element 516, for example, a speaker, coupled to any of processors 510. Electronic device 504 may include a video input element 518, for example, a video camera or camera, and a video output element 520, for example an LCD display, coupled to any of processors 510. Electronic device 504 also includes a keyboard 515 and touchpad 517 which may for example be a physical keyboard and touchpad allowing the user to enter content or select functions within one of more applications 522. Alternatively the keyboard 515 and touchpad 517 may be predetermined regions of a touch sensitive element forming part of the display within the electronic device 504. The one or more applications 522 that are typically stored in memory 512 and are executable by any combination of processors 510. Electronic device 504 also includes accelerometer 560 providing three-dimensional motion input to the process 510 and GPS 562 which provides geographical location information to processor 510.

Electronic device 504 includes a protocol stack 524 and AP 506 includes a communication stack 525. Within system 500 protocol stack 524 is shown as IEEE 802.11 protocol stack but alternatively may exploit other protocol stacks such as an Internet Engineering Task Force (IETF) multimedia protocol stack for example. Likewise AP stack 525 exploits a protocol stack but is not expanded for clarity. Elements of protocol stack 524 and AP stack 525 may be implemented in any combination of software, firmware and/or hardware. Protocol stack 524 includes an IEEE 802.11-compatible PHY module 526 that is coupled to one or more Front-End Tx/Rx & Antenna 528, an IEEE 802.11-compatible MAC module 530 coupled to an IEEE 802.2-compatible LLC module 532. Protocol stack 524 includes a network layer IP module 534, a transport layer User Datagram Protocol (UDP) module 536 and a transport layer Transmission Control Protocol (TCP) module 538.

Protocol stack 524 also includes a session layer Real Time Transport Protocol (RTP) module 540, a Session Announcement Protocol (SAP) module 542, a Session Initiation Protocol (SIP) module 544 and a Real Time Streaming Protocol (RTSP) module 546. Protocol stack 524 includes a presentation layer media negotiation module 548, a call control module 550, one or more audio codecs 552 and one or more video codecs 554. Applications 522 may be able to create maintain and/or terminate communication sessions with any of devices 507 by way of AP 506. Typically, applications 522 may activate any of the SAP, SIP, RTSP, media negotiation and call control modules for that purpose. Typically, information may propagate from the SAP, SIP, RTSP, media negotiation and call control modules to PHY module 526 through TCP module 538, IP module 534, LLC module 532 and MAC module 530.

It would be apparent to one skilled in the art that elements of the electronic device 504 may also be implemented within the AP 506 including but not limited to one or more elements of the protocol stack 524, including for example an IEEE 802.11-compatible PHY module, an IEEE 802.11-compatible MAC module, and an IEEE 802.2-compatible LLC module 532. The AP 506 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 504 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

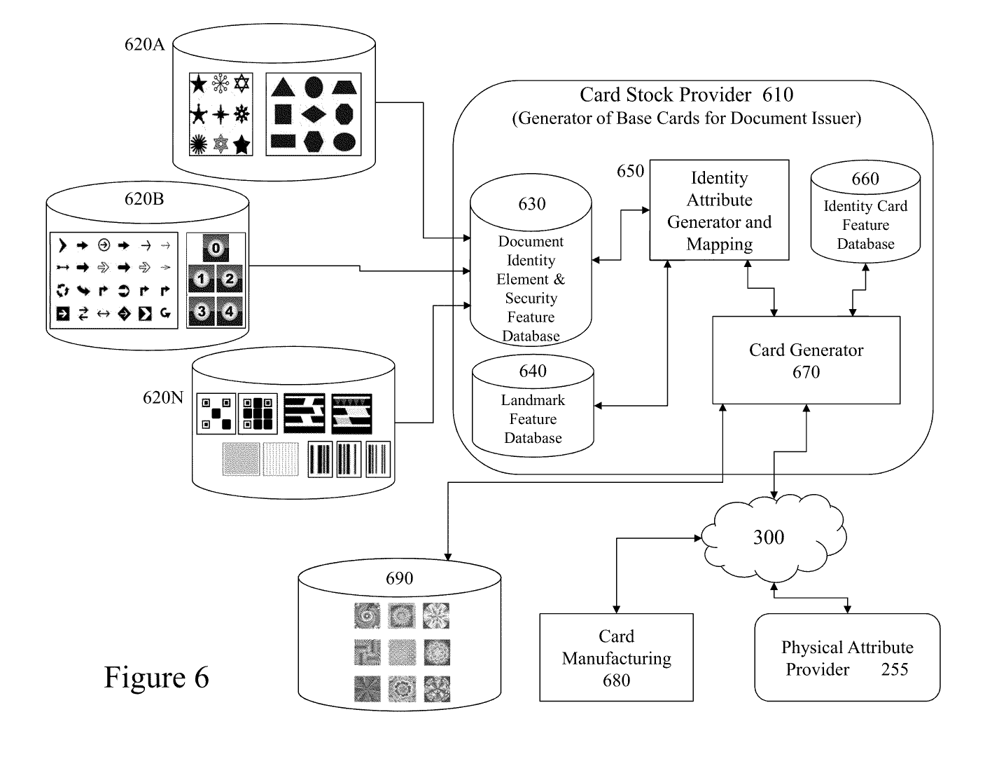

Referring to FIG. 6 there is depicted an architecture for a card stock provider 610 and card manufacturer 680 according to an embodiment of the invention to provide unique base cards through mechanical, non-visible, and visible features. Accordingly, card stock provider (CASP) 610 comprises a Card Generator (CARGEN) 670 in communication with an Identity Attribute Generator and Mapping (IDAGEM) module 650 and Identity Card Feature Database (ICFEB) 660 together with Card Manufacturing 680 and PHYSAP 255. Accordingly, upon a request from PHYSAP 255 for one or more card credentials 260 the CARGEN 670 extracts data relating to the card credential from the ICFEB 660 and generates a request to IDAGEM 650. The extracted data may include, but not be limited to, location(s) of electronic circuit interface(s), location(s) of magnetic stripe(s), location(s) of signing strip(s), location(s) of embossed features, the cardholder's name, and location(s) of logos or other elements. Additionally, the extracted data may include data relating to the addition of mechanical, non-visible and visible features for the PHYSAP 255 such as, for example, the number of features, restrictions on specific categories of features, restrictions on dimensions, etc. In some embodiments of the invention the card credential 160 may be intended for use with card readers other than the terminal 315 or those associated with Store Front Relying Parties 370, e.g. terminal 315, wherein the capabilities of the card reader may be higher or lower than those of the terminal 315.

Accordingly, the IDAGEM 650 establishes a mapping of features for the card credential 260 and through feature extractions from Document Identity Element and Security Feature Database (DOCIDES) 630 and Landmark Feature Database (LAFED) 640 generates the feature maps for the card credentials 260. Each card credential 260 is generated using a new feature set extracted from the DOCIDES) 630 and LAFED 640. Accordingly, the generated feature map(s) is provided from IDAGEM 650 to CARGEN 670 wherein it is combined with physically attached feature mapping based upon element identities stored within first database 690. Such physically attached features may include, but not be limited to, holographic stickers. The DOCIDES 630 is provided with features based upon elements extracted from a plurality of feature databases 620A to 620N respectively. Optionally, elements within one or more of feature databases 620A to 620N respectively may be designed specifically or these may be extracted from commercial/non-commercial sources including images/features extracted from the Internet. The resulting feature profile of each card credential 260 is then provided to the card manufacturing 680 and PHYSAP 255. The card manufacturing 680 may also receive additional information from PHYSAP 255 as well as providing information to the PHYSAP 255. For example, a feature map provided to the card manufacturing 680 by Card Stock Provider 610 via CARGEN 670 may be associated with user 165 data provided by PHYSAP 255 in order to generate the physical card credential 160 and then this binding of feature map and user data provided is provided back to PHYSAP 255. At this stage information within other elements of the card credential 160 such as within an embedded memory, magnetic stripe etc. may also be made such that the finished card credential 160 may be provided to the PHYSAP 255 completed or alternatively be provided directly to the user 165. Alternatively, card manufacturing 680 may provide a stock of card credentials 2160 to the PHYSAP 155 wherein the binding of user to the card is then undertaken by PHYSAP 155 in conjunction with the addition of information within other elements of the card credential 160 such as within an embedded memory, magnetic stripe etc. in order to yield the finished card credential 160.

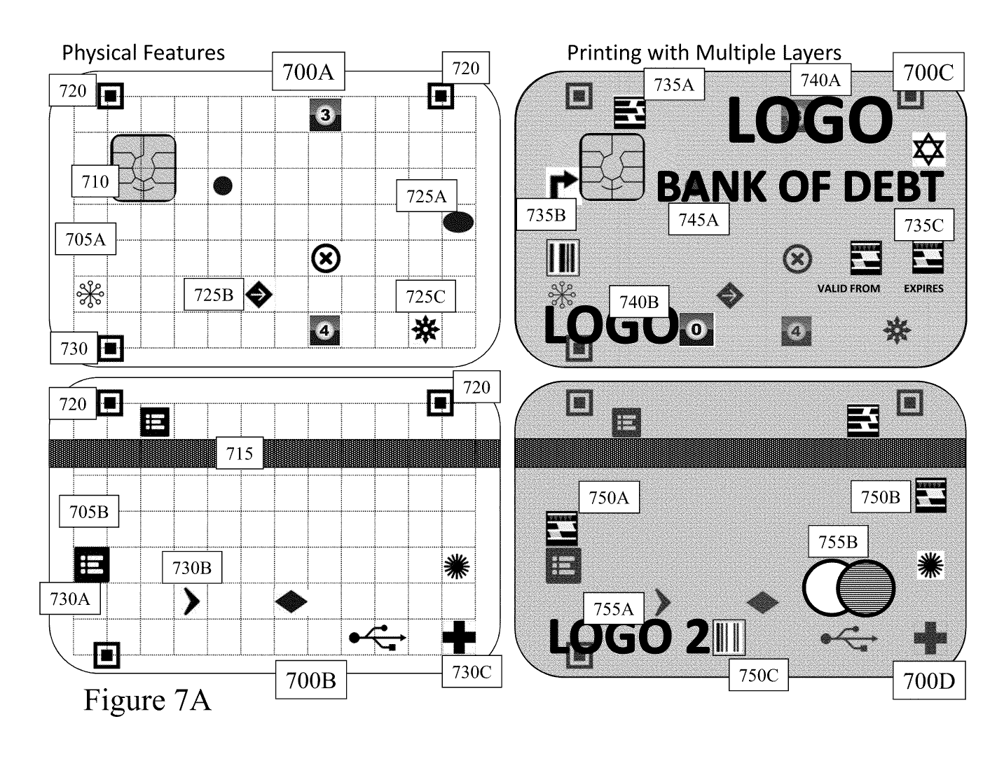

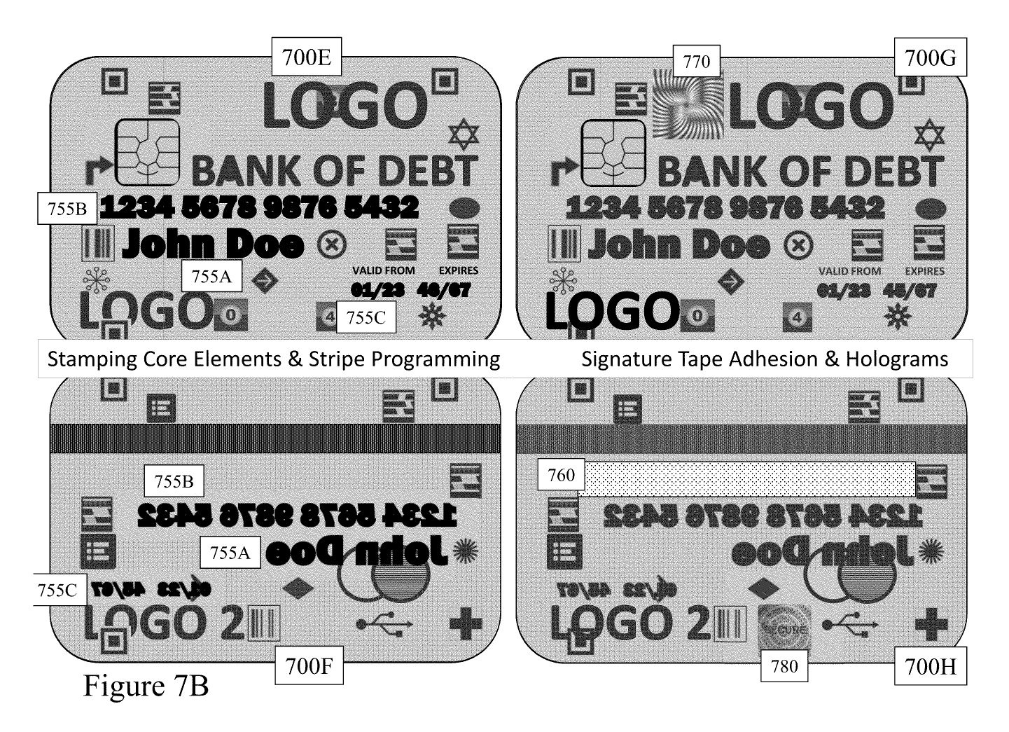

Now referring to FIGS. 7A and 7B there are depicted images for a card credential 260 as manufactured according to an embodiment of the invention via the sequential application of mechanical, non-visible and visible features in order to generate unique base card stock prior to the application of conventional prior art identity and security features. Referring to first front 700A and first rear 700B a card credential 260 is depicted after a blank card has been processed to add mechanical features. The blank card, not shown for clarity, may for example be a plastic card manufactured to a standard, e.g. ISO/IEC 7810 ID-1 or ISO/IEC 7816, with dimensions 85.60 mm×53.98 mm×0.76 mm and rounded corners with a radius of 2.88-3.48 mm. Accordingly, formed within the blank card are any electrical circuit connection 710, magnetic stripe 715, wireless antenna, electronic circuits, and electronic memory (as specified by ISO/IEC 7816 for example). Alternatively, blank card may be in other embodiments of the invention non-standard.

Accordingly as depicted in first front 700A and first rear 700B in FIG. 7A a series of landmark features 720 are provided on each surface. The series of landmarks 720 provide orientation and alignment for subsequent feature extraction through a card reader such as described supra in respect of embodiments of the invention. As depicted the series of landmarks 720 are positioned relative to front and back virtual grids 705A and 705B that provide an array of feature locations, in this instance within a 12 column by 7 row matrix. Within matrix cells are front mechanical features, such as first to third front mechanical features 725A to 725C respectively, and rear mechanical features, such as first to third rear mechanical features 730A to 730C respectively. It would be evident that other

Subsequently, as depicted in second front 700C and second rear 700D in FIG. 7A the card credential is printed. Accordingly, during printing first to third invisible features 735A to 735C are formed upon the second front 700C and fourth to sixth invisible features 750A to 750C are formed upon the second rear 700D. These first to third invisible features 735A to 735C and fourth to sixth invisible features 750A to 750C being similarly orientated with the front and back virtual grids 705A and 705B, not shown for clarity in second front 700C and second rear 700D. Also depicted are first and second front logos 740A and 740B, PHYSAP name 745A, and first and second rear logos 755A and 755B respectively. First and second front logos 740A and 740B, PHYSAP name 745A, and first and second rear logos 755A and 755B respectively which provide visual information to the user 265 or those employing the card credential as part of a transaction etc. are typically printed only in inks, pigments, dyes, etc. that provide visual information within the visible wavelength range of the human eye.

In contrast, first to third invisible features 735A to 735C and fourth to sixth invisible features 750A to 750C which are intended to be used as part of the validation and verification process for the card credential and/or the card stock may be printed within a combination of inks, pigments, dyes, etc. that provide visibility of their associated features under non-visible inspection and/or illumination including for example that made under one or more of ultraviolet, visible, and infra-red wavelengths. Examples may include applying an ultraviolet absorbing ink such that a feature is a dark region on an image of the card credential, applying an infrared absorbing dye such that a feature is a dark region on an image of the card credential, applying a fluorescent material such that only under ultraviolet illumination a feature is visible in the visible region of the spectrum, applying a material such that only under visible illumination is a feature visible in the infrared, and applying a material such that only under infrared illumination is a feature visible in the visible region of the spectrum. In addition to fluorescent materials photoluminescent materials may be employed such that features are only visible once the card credential has been illuminated and the illuminating light removed. Such photoluminescent materials may “glow” or emit, for example, in yellow-green, blue-green, blue, orange-red, purple, and white regions of the visible spectrum and be identified through one or more filters such that white features may be identified separately from orange-red or yellow-green. Alternatively, the blank card may include some features such as first and second front logos 740A and 740B, PHYSAP name 745A, and first and second rear logos 755A and 755B respectively according to manufacturing process considerations, manufacturing costs, etc.

Accordingly, in such instances data retrieved from ICFEB 660 may include identification of the card stock to be employed in the manufacturing process. Accordingly, the card credential is provided with a plurality of features that are mechanically imprinted and/or optically imprinted according to the mapping established by the IDAGEM 650. This mapping may establish a random or pseudo-random number of features upon one or both sides of the card credential within random or pseudo-random locations within the matrix wherein each feature is randomly or pseudo-randomly selected from one or more databases comprising features. Optionally, the mapping may itself be random or pseudo-randomly defined rather than being established with respect to a matrix. Optionally, multiple matrices may be established for the placement of features, these multiple matrices established in dependence upon other elements of the card credential such as electronic circuit interfaces, for example. Optionally, features may also be mapped into the other visual elements of the card credential, e.g. an ultraviolet fluorescent material overlaying part of the card issuer logo, an infra-red absorber established within the card type logo, e.g. MasterCard™.

Subsequent to the printing step described in respect of second front 700C and second rear 700D the card credential may be embossed such as depicted in third front 700E and third rear 700F in FIG. 7B with information such as the card number 755B, cardholder name 755A, and issue and expiry dates 755C for example. Then as depicted in fourth front 700G and fourth rear 700H other elements may be attached to the card credential such as first and second holographic stickers 770 and 780 respectively and signing strip 760. At this point the card is ready for programming the electronic circuit and/or electronic memory and the magnetic stripe 715. It would be evident to one skilled in the art that the sequence of manufacturing steps described and depicted with respect to FIGS. 7A and 7B may be varied according to the manufacturing processes utilized. Accordingly, embossing of the card credential may be the last processing step or alternatively the first. Similarly, application of the mechanical features may be the last processing step, e.g. laser ablation, thermal embossing, etc. or it may be the first step. Optionally, one or more printing, inking, dying or other processes for applying ultraviolet, infrared, and/or visible may be made as the last processing step or a first processing step. Some steps may be distributed across the manufacturing sequence.

Within FIGS. 7A and 7B the features described in respect of providing each base card stock element for a card credential as being unique have been depicted as relatively large elements. However, it would be evident that the features may be of different dimensions including, for example, features smaller or larger than the relative dimensions depicted relative to the card credential wherein the lower dimensional limit may be established based upon the characteristics of the card reader wherein these lower dimensional limits may be different for mechanical, ultraviolet, visible and infrared features. Optionally, all features may be at the same dimension whereas in other embodiments of the invention the features may be of variable dimensions within different regions of the card credential and/or based upon the type of feature. Similarly, a matrix against which features may be placed may be a larger matrix than that described or a smaller matrix. Within other embodiments of the invention the matrix may be established based upon the feature dimensions, minimum feature dimensions, number of features, etc. The number of features may be a constant, a variable, a constant established in dependence upon the type of card, a constant established in dependence upon the card issuer, a pseudo-randomly generated number, or a variable within a predetermined range for example. Selection of the features may be random from a database of features, pseudo-random from a database of features, sequentially extracted from a database of features, or extracted by one such methodology as well as others from a variety of online and non-online sources. Storage of features employed upon a card credential may be by identifier of the feature, a number of the feature within a database, or the feature itself, for example. Features added mechanically may be formed within the surface of the card, e.g. engraving, etching, laser ablation, embossing, etc. or formed upon the surface of the card, e.g. removal of remainder of card surface, deposition, etc.

ID documents within the prior art exploit textual-only identifiers that are then used to assert the document validity, lookup and access database information about the document holder and other document and holders attributes, and often to authorize facility access. These identifiers are easy to generate and are stored in document issuer databases and they are the key to accessing individual records or providing access. An ID document counterfeiter need only “borrow” an existing identity and document identifier to produce valid ID documents with all the security features, laser engravings and the imposter's photo or signature. For all intents and purposes, it is a valid document and it is not recognizable by a human trained in the art of detecting fake identity documents. The problem is that the virtual identity can now be bound to the wrong physical person without any trace of tampering. Within the embodiments of the invention described with respect to FIGS. 6, 7A and 7B and by the inventors within U.S. Provisional Patent Application 61/980,785 entitled “Methods and Systems relating to Real World Document Verification”, the entire contents of which are included by reference, specific features of the ID document are provided which are machine readable and establish a “fingerprint” of the ID document which can then be used to obtain verification and/or authentication data to a user authenticating or validating the presenter of the ID document. For example as described within U.S. Provisional Patent Application 61/980,785 entitled “Methods and Systems relating to Real World Document Verification” the inventors teach the transmission of a photographic image bound to the ID document at issuance for the user to verifier the individual presenting the ID document irrespective of whether the ID document does or does not contain a photographic image of the alleged credential holder.

Accordingly, embodiments of the invention exploit images including the document holder's face and their signature but these are used for in-person identity binding of the physical person with their virtual identity and/or the ID document(s). These images are not subsequently employed as keys to access associated database records or to confirm that the individual within the image corresponds to the textual data attributes presented on the ID document or its associated machine-readable data.

Within the prior art scanning image components such as faces and signatures with document scanners to use as a digital key to access database records or a matching field to corresponding stored data has not been practical. These processes depend heavily upon a variety of factors including, but not limited to, printed resolution, scanning resolution, color variations, lighting and quality defects, etc. which are all difficult problems to tackle even individually yet each completely changes the resulting digital image. Furthermore, security features such as tamper-proof films, nanostructure diffracting patterns, holographic overlays and background or contour differences make such a task even more difficult as these are artificial unpredictable artifacts. In the instance of faces then the feature extraction process requires sufficient resolution and image quality to render the image devoid of overlaying artifacts. These are all conditions and requirements difficult enough to meet on an ID document just issued under controlled conditions to still present numerous challenges in the areas of template matching with the document issuer's photo ID database. Whilst possible, facial matching of ID documents has until now presented enormous challenges.

However, in contrast a fractal image is a geometric image that that follows a precise mathematical algorithm that exhibits a repeating pattern that displays at a large range of scales. Fractal images can be either deterministic or stochastic (random) or a combination of the two, i.e. some parts deterministic and some stochastic. Accordingly, the inventors have established methodologies and systems exploiting fractal images that can be generated and used as unique identifiers for ID documents either solely or in combination with other data which may include data embedded within the fractal image at its generation.

As noted above a human face can be a difficult image to render precisely. A fractal image can be just as varying in contrast and complexity but on the other hand is typically higher/sharper in contrast than a human face. Further, as a fractal image can contain a deterministic component then we have a key that gives prior information regarding the image which can be used to improve the reading of the fractal image.

Now referring to FIG. 8A there is depicted the application of fractal imagery and embedded encrypted data within the fractal imagery in combination with conventional prior art identity and security features according to an embodiment of the invention. Referring to FIG. 8 there are depicted first to third driving licenses 810 to 830 respectively all purporting to be issued by the Province of Ontario, Canada with respect to Sal Khan. As depicted in first driving license 810 the issued Province of Ontario driving license contains first and second images 811 and 812 respectively together with signatures 813 and 814. As evident each of the first to third driving licenses 810 to 830 respectively comprises information relating to the driver, e.g. their name, residential address, their height, sex, allowed driving vehicle classes, and date of birth in combination with official driving license reference, issue date and expiry date. The card contains basic prior art security features such as fine printing in the border, embedded micro-text within the background across the card etc. However, these features are common to every Province of Ontario driving license and do not uniquely identify the card according to the prior art.

Accordingly, it would be evident that the methodology described above in respect of FIGS. 6, 7A and 7B would allow the card stock to be manufactured uniquely for each driving license. Hence, a unique card is printed for the intended driver of their driving license and stored within the databases such as described supra allowing subsequent verification of the card against the holder presenting it. Accordingly, a CARCREC system 310 as described in FIG. 3 may be extract information from the card and the information can independently verified by a PHYSAP 255 against that issued for the card originally. Accordingly, the physical and visual/non-visual elements embedded into the card at manufacturing as described in respect of FIGS. 6, 7A and 7B are read by a CARCREC system 310 or similar system installed within other electronic equipment including, but not limited to, automatic teller machines (ATMs), police enforcement in-vehicle systems, etc. This data then results in the PHYSAP 255 extracting data relating to the user to whom it was issued which within a first embodiment of the invention is compared to other data retrieved from the credential presented, e.g. image of photograph, scan of signature etc. In a second embodiment of the invention, e.g. a police enforcement in-vehicle system this may receive a pre-determined portion of the content from the PHYSAP 255. Accordingly, a police officer would be provided with an image of the legitimate holder of the driving license allowing them to visually compare to the individual presenting it. In contrast, a store holder may simply be a visual indication that the credential is fake as the image data captured from the card does not match the originally issued data.

In the instance of first driving license 810 such verifications would trigger failed verification etc. as in fact the originally issued driving license looked like second driving license 820 with first and second original owner images 821 and 822 rather than the first and second images 811 and 812 which have been subsequently placed onto the driving license. However, absent such verification through the PHYSAPP 255 due to the unique nature of the card stock for the driving license then if the driving license was presented to a police officer, postal office worker to collect a parcel, etc. then all appears correct. Accordingly, if Sal Khan has a clean license and the individual whose photograph is appended to it is barred from driving then current credentials would not trigger identification of the suspended driver or the individual in the postal office scenario would be able to collect materials intended for the legitimate owner of the driving license. As these materials may have been purchased online with stolen credit card information then the thief can collect the item(s) themselves.

However, referring to third driving license 830 a fractal image 831 has been added to the driving license at original issuance. Accordingly, this fractal image may within some embodiments of the invention be applied to the card stock prior to the printing of the specific information relating to the issuing authority and/or individual so that the original card is uniquely patterned with this fractal image discretely or in combination with other visible, non-visible and mechanical features such as those described supra in respect of FIGS. 6, 7A and 7B respectively. The printing of this fractal image 831 may therefore be undertaken using printing equipment providing colours, resolutions, patterns, etc. not achievable through lower quality printing equipment employed within the actual manufacturing of the final issued card, for example.

Within the prior art machine-readable marks such as 1D and 2D barcodes address the readability problem by combining simple geometric symbols. Each represents specified corresponding numerical values into defined repetitive patterns that are optimized for error correction in many cases. 2D or matrix barcodes such as PDF417, a Portable Data File (PDF) where each pattern in the code consists of 4 bars and spaces and that each pattern is 17 units long, and Quick Response (QR) are widely used when data is more than a numeric identifier. The latter is optimized for a greater readability and compactness as well as selectable error correction sensitivity. While these technologies do look like images, they are really machine-readable textual fields on the ID document with the same limitations as identified previously. They do highlight error correction approaches such as the Reed-Solomon error-correction algorithm which implements known ways to guard against multiple random errors such as destroyed portions of an image. However, this is limited.

In the case of a fractal image, however, the inventors consider its repeating content as making it more robust with regard to image distortion from use and providing superior in readability for real world conditions. Fractal images are self-similar patterns that are nearly the same at every scale making every part of it characteristic of the whole. Accordingly, quality defects on the ID document being read and disparities in reader technologies should be overcome by factoring in the multiple repeating regions at various scales within the fractal image. Beneficially, the inventors exploit this characteristic of the fractal images to make it possible to include support for inexpensive optical reading devices such as simple hand held cameras as well as more expensive optical reading devices. Other machine-readable barcodes are just not as resilient or scalable to real-world conditions and often require magnetic, laser or high-resolution scanner devices that are specialized and expensive. This is not the case with fractal images. Further, in addition to the self-similar nature of fractal images the exhibited patterns can be both unique and extremely detailed providing the capacity for superior information storage in comparison to existing technologies. Conversely, they also support the incorporation of a random component rendering the reproduction of the fractal image mathematically impossible. They also support the embedding of data within the fractal image during their generation rendering that embedding invisible to prior art techniques to identify content stenographically hidden within an image.

In this manner each card within the generated card stock may contain a fractal image that cannot be generated by lower quality printing systems. Alternatively the card may contain a fractal image within which is embedded encrypted data. For example, data to be embedded may be encrypted using a hash function from the Secure Hash Algorithm 2 (SHA2) family and then a fractal generated, for example, via an Integrated Function System (IFS). The hashed data is then hidden within the fractal image using a methodology such as chaos theory and applied through a process, e.g. a generalized Fibonacci sequence. Subsequently, the encrypted and hidden data may be extracted through a reverse process applied to a scanned image of the fractal image wherein the hashed value is extracted through a hashing algorithm applied to the scanned data to separate the hashed value from the fractal image data.

Referring to FIG. 8B there is depicted an exemplary process flow for embedding data within a fractal image to form part of a card according to an embodiment of the invention. As depicted the process comprises first and second sub-flows 800A and 800B. Within first sub-flow 800A comprising steps 840 to 860 the data to be embedded is acquired and encrypted whilst within second sub-flow 800B comprising steps 865 to 880 wherein the fractal image is established and generating data acquired. These steps being:
Step 840—the data to be encrypted, (M), is acquired from a database in relation to the card to which the image being generated will be applied;
Step 845—data (M) within remote data store to be encrypted
(M)=Sal Khan 769 Montcrest Avenue Ottawa K4A 2M719411215 K3175068404-11215
Step 850—the encryption function, e.g. SHA-256, is selected for hashing the data (M);
Step 855—the hashing is performed, Hv=H(M), to generate the hashed value, Hv, from the data (M) and the encryption function;
Step 860—the hash value, Hv=72cd7a9c21f410c693c88b1a54bf3d70 c0d00c30a1ac521a7c24a9b0167221a3;
Step 865—select fractal type;
Step 870—establish IFS for fractal type selected;
Step 875—retrieve affine transformation coefficients for generating the fractal image;

and
Step 880—generate image by selected methodology using IFS with affine transformations and embedding hashed value, Hv.

Accordingly, in this embodiment of the invention the embedded hashed value is not added to the fractal image once generated but rather merged during the generation of the image. In this manner the resulting combined image is immune to many common stenographic algorithms typically employed to extract data hidden conventionally via stenographic techniques as these the data to a final image. It would be evident that a SHA-2 cryptographic hash is a one-way function in that it cannot be decrypted back. However, this makes it particularly suitable for password validation, challenge hash authentication; anti-tamper, and digital signatures. Accordingly, the hashed value retrieved from the card may be compared to a second hash value obtained from a separate source, e.g. a PHYSAPP 255, based upon the other features of the card or its content etc. read by a CARCREC system 310 using processes such as those described supra. Optionally, the fractal image with embedded data may, as opposed to being displayed as fractal image 831 may be combined with another image, e.g. the driver's image, the trillium flower, etc.

As discussed previously, one of the weaknesses of textual identifiers and prior art security features found in ID documents is the inability to guarantee that the document textual data uniquely matches the holder facial and signature images. Whilst the in-person validation by an authorized agent ensures the ID holder presenting the ID document and their facial image are the same, this in no way ensures their virtual identity is in fact for that physical person. Within U.S. Provisional Patent Application 61/980,785 entitled “Methods and Systems relating to Real World Document Verification” the inventors teach the transmission of a photographic image bound to the ID document at issuance for the user to verify the individual presenting the ID document irrespective of whether the ID document does or does not contain a photographic image of the alleged credential holder.

Within the embodiments of the invention presented here the deterministic characteristics of the generated fractal images are aimed by the inventors at linking exactly and locally the variable security pattern to the ID document facial identification and other identification data, making modification impossible as the fractal image pattern would then become incompatible with the other identifiers. Accordingly, within embodiments of the invention an algorithm may be employed to uniquely measure locked aspects of the ID document to their counterparts within the fractal image in a simple yet definite way.

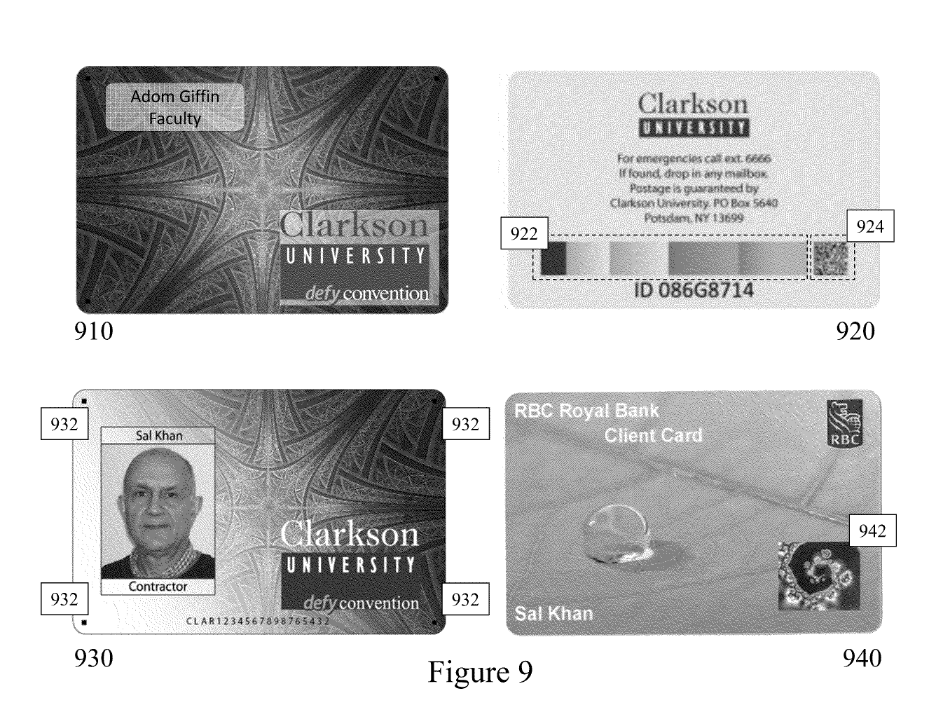

Now referring to FIG. 9 there are depicted first to third images 910 to 930 respectively in respect of the application of fractal imagery and embedded encrypted data within the fractal imagery in combination with conventional prior art identity and security features according to an embodiment of the invention. First and second images 910 and 920 respectively refer to a Clarkson University identity card relating to Adom Giffin with his name and department, i.e. Faculty, listed. On the front surface in first image 910 the card does not contain an image but is patterned with a fractal image within which the image of Adom Giffin is embedded according to embodiments of the invention. In this instance an attempt to adjust the card to another user such as depicted in FIG. 8A by replacing images of the original user is impossible as no image exists to replace. Accordingly, when the card is read within a CARCREC 310 the image of the individual to whom it was issued is displayed based upon its extraction from the fractal image. Alternatively, the fractal image may contain data for the CARCREC 310 to provide to the PHYSAPP 255. As depicted the rear side of the card is depicted in second image 920 comprising colour code bar 922 and 2D code 924.

Third image 930 depicts an alternate card with fractal image but now containing also an image of the individual to whom the card is purported to belong together with a code, i.e. CLAR1234567898765432. Additionally, the card comprises four orientation markers 932 allowing a CARCREC 310 to align the scanned/acquired images in horizontal/vertical directions as well as providing horizontal and vertical scaling allowing the identification of the region within the fractal image that will be analysed to extract the data from as the embedding of the data within the fractal image may itself be performed in a series of steps each relating to a different portion of the overall image forming the pattern on the card. Equally in other embodiments of the invention the fractal image may form only part of the card and the embedded data encrypted or otherwise provided to the generating program may be added to portions of the fractal image rather than within the whole image. Within embodiments of the invention the encryption employed may be not part of the encrypted data so that only a valid CARCREC 310 may retrieve an encryption code from a PHYSAPP 255. Alternatively, the CARCREC 310 extracted data is used to verify the card through its transmission to the PHYSAPP 255. Fourth image 940 represents a financial credential employing a fractal image 942 with embedded data according to an embodiment of the invention.

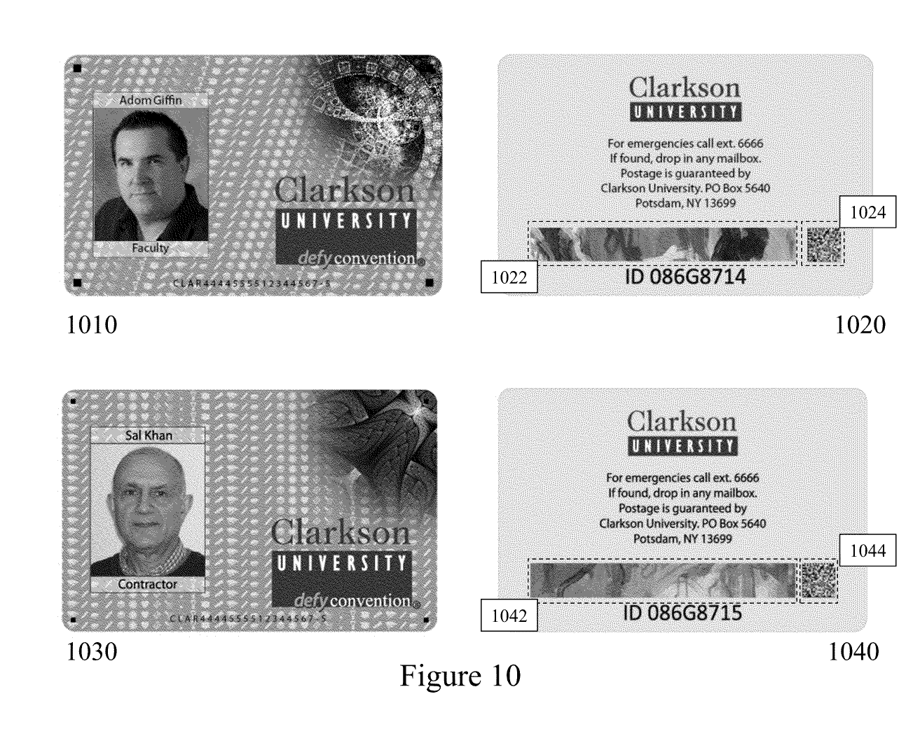

Now referring to FIG. 10 there are depicted first to fourth images 1010 to 1040 images respectively depicting the application of fractal imagery and embedded encrypted data within the fractal imagery in conjunction with mechanical and non-visible features to generate unique base card stock prior to the application of conventional prior art identity and security features according to embodiments of the invention. As depicted first and second images 1010 and 1020 relate to an identity card for Adom Giffin a member of Faculty at Clarkson University in Pottsdam, N.Y. Third and fourth images 1030 and 1040 relate to an identity card for Sal Khan a contractor to Clarkson University. In each instance the front surface of the card, first and third images 1010 and 1030 respectively, comprises a fractal image within the upper right corner in conjunction with a photograph of the purported holder of the card. Accordingly, a CARCREC 310 may extract data from the fractal image and capture the photograph to provide to a PHYSAPP 255 for authentication/verification. Additionally, it can be seen that the remainder of the front surfaces of the cards in first and third images 1010 and 1030 contain a pattern of identification icons which are different. As described supra in respect of FIGS. 6, 7A and 7B then these identification icons may be selected such that, for example, their locations are fixed but their designs vary, their locations vary but the designs are fixed, or the locations and the design vary. As depicted in FIG. 10 the patterns are common but the locations vary.

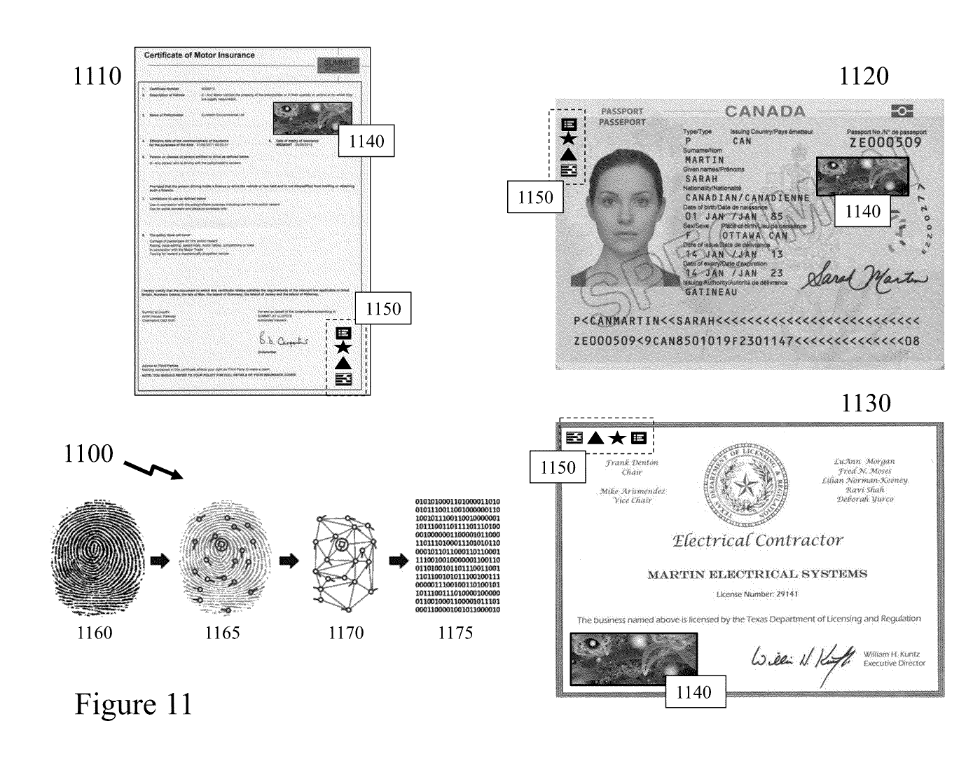

The backside portions of the two cards, depicted in second and fourth images 1020 and 1040, comprise image code bar 1022/1042 and 2D codes 1024/1044 respectively. In contrast to color code bar 922 in FIG. 9 the image code bars 1022 and 1042 respectively which are distorted images containing information content wherein the information content has been merged with a pattern and then distorted according to a predetermined mathematical distortion process. It would be evident to one skilled in the art that such techniques may also be applied to other physical documents at their time of generation such that modification of them may be identified as they will fail verification and/or authentication according to the techniques described supra in respect of embodiments of the invention. In these instances, the fractal image may be decoded at the CARCREC 310 for transmission to the PHYSAPP 255 allowing verification based upon the data extracted from the fractal image and transmission of authentication data to the CARCREC 310. For example, referring to FIG. 11 first to third documents 1110 to 1130 respectively are depicted representing a vehicle insurance certificate, passport page, and business certificate respectively. Within each there is a fractal image 1140 and pattern content 1150, the pattern content being similar to that discussed in respect of FIGS. 6, 7A and 7B wherein this is individually generated for that specific document as is the fractal image 1140 as this has data embedded within. Optionally, the resolution required to print the fractal image may be established such that copying, laser printing, inkjet printing etc. cannot reproduce even if desired. Accordingly, paper stock may be provided with uniquely distributed features such as described in respect of FIGS. 6, 7A and 7B employing one or more of ultraviolet, magnetic, visible, and infrared inks.

Also depicted in FIG. 11 is an exemplary process 1100 for converting biometric data, e.g. fingerprint 1160, into digital data 1175 for embedding within a fractal image, e.g. fractal image 1140 during its generation process. Accordingly, the fingerprint 1160 is initially processed to establish the minutia points upon the fingerprint, these being the locations of major features of the fingerprint ridges such as ridge ending, bifurcation, and short ridge (or dot). The minutia points 1165 are then used to generate a minutia map 1170 which is then converted to the digital data 1170. This digital data, as is or encrypted is then embedded into the fractal image at generation using a process such as that depicted in FIG. 8B, for example.

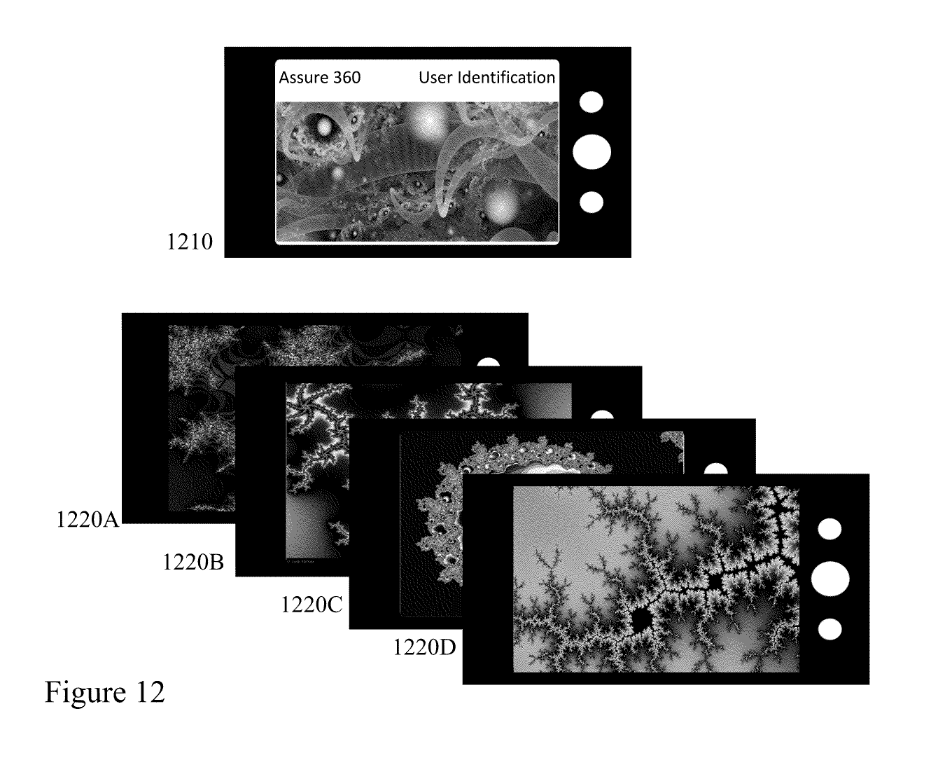

Within an alternate embodiment of the invention, as depicted, in FIG. 12, a fractal image may be generated by a credential management system and provided to a user's PED and/or FED via a secure communications channel, e.g. a financial credential may be provided to the user's PED only when the user visits the financial service provider to whom the financial credential relates avoiding its transmission to an external network, for example. Accordingly, the financial credential, for example, may be a fractal image with embedded encrypted data, e.g. such as fractal image 831 in FIG. 8 provided as an image for display upon the user's PED in order for the user to authorize a financial transaction. Such a display being depicted in first image 1210 in FIG. 12. The fractal image 831 may, alternatively, be one of a set of fractal images provided by the financial institution wherein only one of the set contains the embedded data but all images within the set of fractal images are presented as part of the transaction wherein the embedded information is retrieved from the appropriate fractal image. Such a set of fractal images displayed as part of a financial transaction verification are depicted in first to fourth images 1220A to 1220D respectively in FIG. 12. Which image is associated to the user is only known to the financial service provider. For example, with a high resolution camera within the financial transaction system the set of images may be several or tens of images. Alternatively, the fractal image is only generated for the financial transaction stage and is not stored generally within the user's PED.

Optionally, in addition to the fractal image(s) additional pattern content may be displayed on the PED, the pattern content being similar to that discussed in respect of FIGS. 6, 7A and 7B wherein this may be individually generated for that specific transaction as is the fractal image according to a coding generator within the PED employing a key uniquely stored within the PED, for example, or provided as part of the transaction. Whilst such pattern content cannot be as variable in terms of employing one or more of ultraviolet, magnetic, visible, and infrared inks the content can be temporally displayed such that, for example, the PED display is imaged by the other system for a predetermined period, e.g. 5 seconds and within that a 2 second sequence of the fractal image and temporally varying additional pattern content.

Fractal images allow embodiments of the invention to take full advantage of the ability to use well defined mathematical algorithms that exhibit repeating patterns at multiple scales and can be combined with deterministic and stochastic characteristics. For this reason, such fractal images can each be generated and used as a unique identifier of and on an ID document, in a similar fashion as a facial photograph should be a unique identifier for the document holder. Beneficially, as the identifier is no longer textual, it cannot effectively be guessed or improvised by would-be document counterfeiters as there are virtually unlimited possibilities of fractal variable security patterns without any possibility that an improvised one would correspond to an actual valid ID document record.

Beneficially, once the generated fractal image has been generated and printed onto the ID Document, only one-way calculated image feature marks are required and stored for matching the unique identifier into a fractal features template. Therefore only the fractal template remains in existence and the original fractal image is never retained. This makes it impossible to derive the fractal image from the database record, similar to how it is impossible to derive a fingerprint from a fingerprint template, or a face from a facial template.

In the case of prior art document or document holder identifiers, these are printed and stored both on the document and as-is in the document issuer databases, making both predictable, easy to generate or duplicate should a new document be produced. Therefore, with existing identifiers, counterfeiters need only to choose an existing valid document ID and associated holder attributes to produce a valid document, which is not the case for the proposed technology. With fractal image based variable security patterns, each new document issued necessarily has a new unique fractal image generated.

It would be evident to one skilled in the art that the fractal image techniques according to embodiments of the invention are designed to provide an inexpensive solution as they allow leverage of existing ID document printing technologies and do not in some embodiments require any special inks, overlays, post-processing or special reading devices. It can simply be printed as opposed to a photo identifier that usually needs high resolution for clarity or alternatively the generated fractal image can be stored on an expensive microchip. In either of those cases, the proposed solution is superior as completely secures the document by having a one-way production workflow that cannot be reversed.

It would be evident to one skilled in the art that the fractal image techniques according to embodiments of the invention support the advent and evolution of all-digital ID documents. The fractal image variable security pattern concepts solve the problem of making a unique valid digital document available on mobile devices as the fractal image can be easily displayed upon a PED's display and captured through a camera or other image capturing device but the visual camera friendly security feature cannot be reverse engineered. As discussed above, only fractal templates are stored for matching and original fractals cannot be derived from the fractal features calculated during the fractal generation phase.

It would be evident to one skilled in the art that the fractal image techniques according to embodiments of the invention may support current high-speed ID Document production equipment wherein the variable data and holder specific production phases can reach or exceed a few hundred documents per hour. Accordingly, beneficially the fractal pattern generation algorithms can be implemented to perform within a similar timeframe or improved to an acceptable turnaround time by document issuers so as to not impact their existing processes.

It would be evident to one skilled in the art that the fractal image techniques according to embodiments of the invention also support fractal image based variable security patterns as a path to the first Revocable Hybrid Biometric Identifier (RHBI). Within the pyramid of authentication techniques reside multi-factor authentication methods that, by definition, require biometric identifiers such as face, fingerprint, iris, vein pattern, voice, etc. Amongst the issue to such identifiers is how to make biometric information intrinsically linked to the individual revocable if is ever compromised by some technological means or otherwise. Fractal image based RHBIs exploit generated fractal images incorporating characteristics of an associated biometric characteristic or characteristics, for example, wherein the resulting fractal RHBI is completely unique, revocable, whilst enforcing that the linked biometric has not been modified in any way.

As noted supra digital data, encrypted or not, can be encoded into the fractal image during its generation for subsequent extraction. However, it would also be evident that stenographic techniques may also be applied to add digital data, encrypted or not, to a fractal image after its generation which whilst not as secure as embedding during fractal generation may be beneficial in some instances. Existing barcode and magnetic stripe data storage mechanisms within ID documents are typically limited to small amounts of data, from tens of alphanumerical characters up to a few kilobytes (KB) for large albeit impractical QR codes. Typically data storage is limited to one hundred bytes for typical printable and readable QR codes. Larger storage needs are usually approached with expensive contact or contactless embedded microchips in smartcards that can reach many KB of data storage, which are needed for truly encompassing expanding data needs. For example, facial images typically account for approximately 15-20 KB to be usable for facial recognition, fingerprints account for approximately 10 KB each finger, and iris scans approximately 30 KB each iris. Therefore, 32 KB is considered a minimum data storage capability for official documents with all textual information and the document holder facial image. Accordingly, the inventors believe that by exploiting the deterministic aspects of the fractal image generation the calculated fractal features vector can be expanded to provide data storage capabilities beyond facial image and signature storage.

Accordingly, whilst ID documents have evolved to include increasing complex security features to prevent fraudulent documents being manufactured or individual impersonation, counterfeiters are always adapting to those changes at an equally fast rate. With the increased adoption of mobile payments using smartphones and other PEDs and the gradual elimination of physical documents in favor of digital ones in all sectors of the industry, the shift from ID document borne physical security features to ones that will work with mobile devices is increasingly evident. Embodiments of the invention as described supra work across physical and electronic ID documents equally.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of providing a user with a physical credential comprising data embedded within a fractal image comprising a predetermined portion of the content patterned onto the physical credential.

2. The method according to claim 1, wherein at least one of:
the fractal image is patterned during manufacture of a card stock for the physical credential;
the fractal image is patterned during the generation of the physical credential using a stock card from a pool of card stock;
the fractal image cannot be patterned without specialized printing equipment;
the data embedded into the fractal image is unencrypted and embedded during the generation of the fractal image rather than via a stenographic process;
the data embedded into the fractal image is encrypted and embedded during the generation of the fractal image rather than via a stenographic process; and
the data is embedded to a predetermined portion of the fractal image.

3. A method of verifying an electronic transaction comprising providing as part of the electronic transaction a fractal image comprising data embedded within the fractal image comprising a predetermined portion of the electronic transaction.

4. The method according to claim 3, wherein at least one of:
the fractal image is generated only as part of the electronic transaction;
the fractal image is provided by a financial service provider for use when the electronic transaction involves the financial service provider;
the data embedded into the fractal image is unencrypted and embedded during the generation of the fractal image rather than via a stenographic process;
the data embedded into the fractal image is encrypted and embedded during the generation of the fractal image rather than via a stenographic process; and
the fractal image is one of a set of fractal images employed within the electronic transaction.

5. A method of digitally securing an item of content by generating a fractal image for incorporation with the item of content, wherein the fractal image is generated using a fractal generation process that is both deterministic and stochastic.

6. The method according to claim 5 wherein the fractal generation process incorporates digital data from a data file into the fractal image during its generation.

7. The method according to claim 5 wherein the fractal generation process incorporates digital data from a data file into the fractal image during its generation, wherein the data file comprises at least one of digitized biometric data, encrypted digitized biometric data, user data, encrypted user data, content data relating to the item of content and encrypted content data relating to the item of content.
